(19) United States
(12) Patent Application Publication
(10) Pub. No.: US 2003/0067860 A1
(43) Pub. Date: Apr. 10, 2003

(54) Near-field optical flying head

(75) Inventors: Shih-Che Lo, Ilan (TW); Horng-Nien Wang, Taipei (TW); Hsi-Hsiang Lin, Ilan (TW)

Correspondence Address: BROWDY AND NEIMARK, P.L.L.C., 624 NINTH STREET, NW, SUITE 300, WASHINGTON, DC, 20001-5303, US

(73) Assignee: INDUSTRIAL TECHNOLOGY RESEARCH INSTITUTE, Hsinchu (TW)

(21) Appl. No.: 09/973,091

(22) Filed: Oct. 10, 2001

(51) Int. Cl. G11B 7/135

(52) U.S. Cl. 369/112.24

(57) ABSTRACT

A near-field optical flying head includes a carrier maintained in a near-field distance from the surface of a disk to be recorded, a SIL (solid immersion lens) mounted on the front side of the carrier, a focusing lens mounted inside the carrier and adapted to focus laser beam onto the SIL, the SIL having a refraction face plated with a light scattering layer and a dielectric layer on the light scattering layer for releasing silver atoms to produce an optical aperture for the passing of laser beam upon the radiation of laser beam. In an alternate form of the invention, the refraction face of the SIL is plated with a mask layer and a dielectric layer that changes the refraction index to produce an optical aperture in the focused point for the passing of electromagnetic wave when heated by heat energy of laser beam.

### FIELD OF THE INVENTION

The present invention relates to laser disk read-write heads and, more specifically, to a flying head for near field recording.

### BACKGROUND OF THE INVENTION

Laser disks including CDs, VCDs, DVDs, MDs, and etc., have been intensively used as data storage medium for the advantages of high capacity, low cost, high portability, and durable use. Following the presence of AV (audio video) multimedia age, the demand for laser disk storage capacity becomes heavier than ever. It is important to increase the storage capacity of a laser disk without changing its dimension.

Various laser disk storage capacity improvement techniques have been developed. FIG. 1 shows a near field recording technique according to the prior art, which reduces the spot size of laser beam emitted by the read-write head to expose (write data into) the laser disk, so as to expose signal groove of thinner line width, increasing the storage capacity of the laser disk. In brief, this method uses a server system to control a flying head 90 to “fly” on the surface of the laser disk D at a low elevation (i.e., the near-field distance). The flying head 90 has a semispherical SIL (solid immersion lens) 92 at the front side, and a focusing lens 94 disposed at an inner side and adapted to focus laser beam onto the center area of the refraction face 96 of the SIL 92, enabling a small amount of electromagnetic wave (evanescent wave) to penetrate the refraction face 96 and to expose the laser disk in the near field. Because the spot size of laser beam is indirectly proportional to numerical aperture, the high refraction index of the SIL 92 reduces the speed of laser beam, forming 1/n wavelength (because the distance between the refraction face and the laser disk is smaller than λ, light wave does not resume to its original wavelength when passed through the refraction face). Therefore, diffraction limited becomes 1/n of a regular lens, i.e., numerical aperture is increased by n times, and the spot size of light emitted onto the disk is relatively reduced to achieve a thin line width exposure operation.

The aforesaid flying head can produce a laser light spot of spot size smaller than that produced by conventional read-write heads for recording more data on the same size of disk. However, consumers never stop their demand for high capacity of data storage media. Further, fast-developed application products also require high capacity of data storage media. Therefore, there is a strong demand for enabling laser disks to store data in higher density.

### SUMMARY OF THE INVENTION

The present invention has been accomplished under the circumstances in view. It is the main object of the present invention to provide an improved structure of near-field optical flying head, which greatly reduces the spot size of laser beam to achieve a thinner line width near-field exposure, so as to further increase the signal track density and storage capacity of the disk.

To achieve this and other objects of the present invention, the near-field optical flying head comprises a carrier maintained in a near-field distance from the surface of the disk to be recorded; a solid immersion lens installed in one side of the carrier, the solid immersion lens having a refraction face facing the disk to be recorded; and a focusing lens installed in the carrier and spaced from the solid immersion lens at an inner side, adapted to focus a laser beam onto the solid immersion lens, enabling a part of electromagnetic wave to pass through the refraction face and to make a near-field exposure to the disk to be recorded; wherein the solid immersion lens comprises a light scattering layer plated on the refraction face and a dielectric layer plated on the light scattering layer, which causes a chemical reaction to release silver atoms and to enhance electromagnetic wave passing through the refraction face in providing a small optical aperture for the passing of laser beam when received light energy or heat energy. In an alternate form of the invention, the refraction face of the SIL is plated with a mask layer that changes the refraction index to produce an optical aperture in the focused point for the passing of electromagnetic wave when heated by heat energy of laser beam.

### BRIEF DESCRIPTION OF THE DRAWINGS

FIG. 1 is a schematic drawing showing the structure of a near-field optical flying head constructed according to the prior art.

FIG. 2 is a schematic drawing showing the structure of a near-field optical flying head constructed according to a first embodiment of the present invention.

FIG. 3 is a schematic drawing showing the structure of a near-field optical flying head constructed according to a second embodiment of the present invention

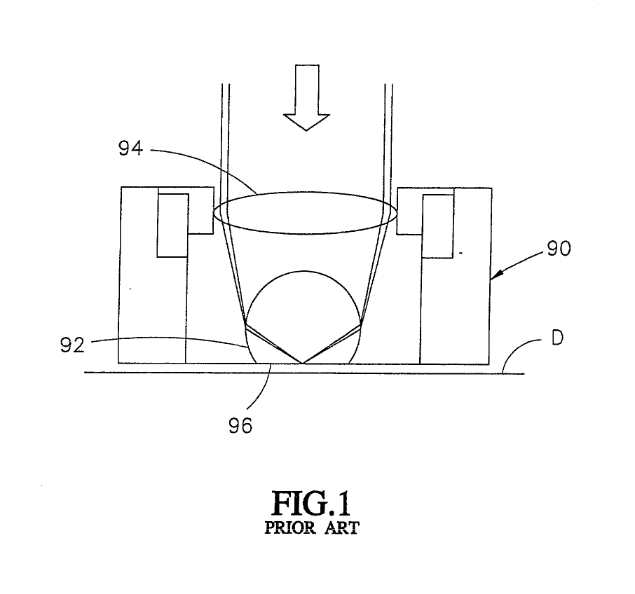

### DETAILED DESCRIPTION OF THE PREFERRED EMBODIMENT

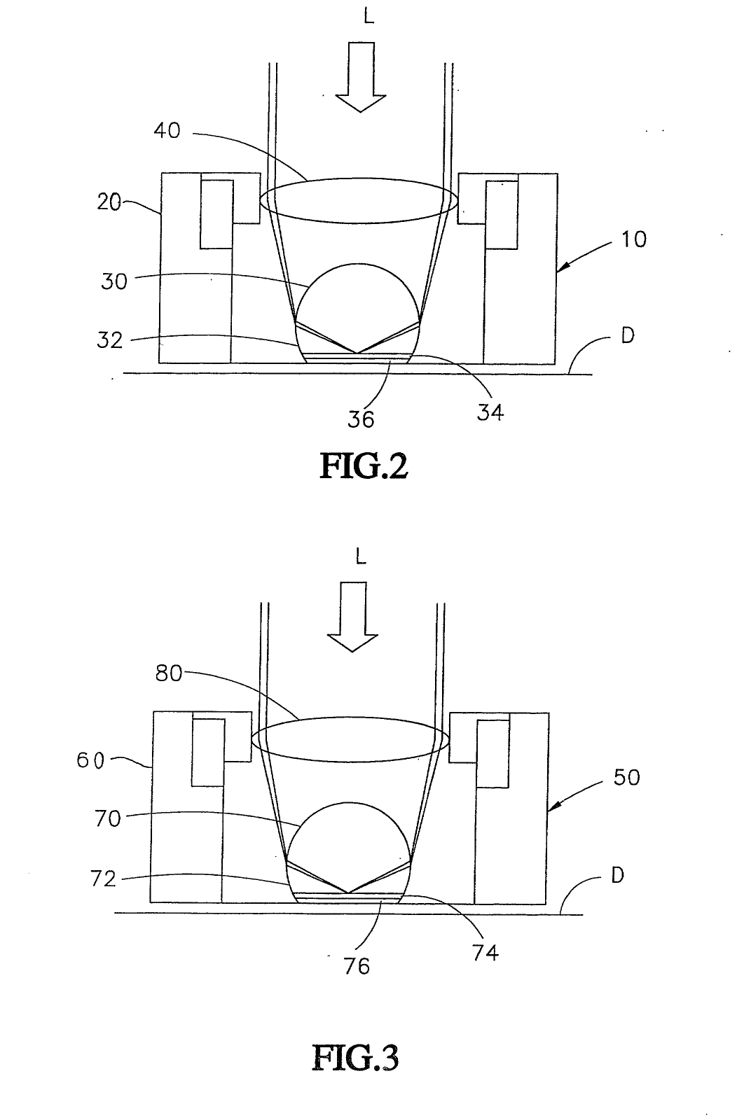

Referring to FIG. 2, a near-field optical flying head 10 is shown comprising a carrier 20, a SIL (solid immersion lens) 30, and a focusing lens 40.

The carrier 20 is an air pad (it is of the known art not the key point of the present invention, therefore it is described in brief hereinafter) controlled by a high-precision server system to fly stably over the surface of the disk D within a short distance by means of aerodynamics. The air gap between the carrier 20 and the disk D is smaller than the wavelength λ of the laser beam, i.e., the carrier 20 is maintained in the near-field distance.

The SIL 30 is made of glass or material having a high coefficient of refraction and installed in the front side of the carrier 20 near the disk D, having a semispherical shape and a refraction face 32 disposed in parallel to the disk D.

The focusing lens 40 is installed in the carrier 20 at an inner side and adapted to focus laser beam L onto the SIL 30 (the laser beam is emitted from a laser diode through a collimated lens, a polarizing beam-splitter cubic and a quarter wave plate toward the focusing lens 40 in direction perpendicular to the disk D).

The aforesaid description is of the known art. The main features of the present invention are outlined hereinafter. The refraction face 32 of the SIL 30 is plated with a light scattering layer 44 by means of evaporation or sputtering, and the outer surface of the light scattering layer 44 is plated with a dielectric layer 46. The light scattering layer 44 has the chemical property of “been decomposed to release silver atoms when received light energy or heat energy; or reduced to its original compound when light energy or heat energy disappeared”. For example, AgOx (silver oxide) can be used for the light scattering layer 44. When heated, AgOx is decomposed into oxygen and silver atoms. On the contrary, oxygen and silver atoms are reduced to AgOx when heat energy disappeared The chemical equation is as follows:

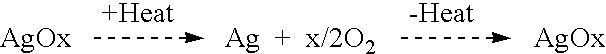

Alternatively, AgX (silver halide) may be used for the light scattering layer 44 in which X of AgX represents F (fluorine), Cl (chlorine), Br (bromine), I (iodine), or At (astatine), i.e., the light scattering layer 44 can be AgF (silver fluoride), AgCl (silver chloride), AgBr (silver bromide), AgI (silver iodide), or AgAt (silver astatide). When heated, AgX is decomposed to release silver atoms. The chemical equation is as follows:

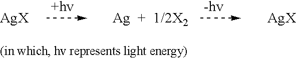

The dielectric layer 46 adopts silicon nitride (Si₃N₄) or zinc sulfide-silicon dioxide (ZnS—SiO₂) to protect the light scattering layer 44, and to prohibit escaping of gas (oxygen, nitrogen) to the outside during chemical reaction of the light scattering layer 44. According to the present preferred embodiment, the light scattering layer 44 covers the whole area of the refraction face 32, and the dielectric layer 46 covers also the whole area of the light scattering layer 44. Alternatively, both 44 and 46 can cover the center area of the refraction face 32 only, i.e., the laser beam focusing area.

When laser beam L passes through the focusing lens 40 toward the SIL 30, it is focused onto the center of the refraction face 32, enabling electromagnetic wave to penetrate the refraction face 32. At this time, the light scattering layer 44 receives the light energy or heat energy of laser beam L, and is caused to release silver atoms within a very short reaction time. Silver atoms increase the energy of electromagnetic wave due to the effect of surface plasma, thereby causing an optical aperture to be opened in the focal point for the passing of laser beam L to have a relatively smaller spot size of the light at (the internal photoresistance layer of) the disk D. Therefore, the invention achieves a thinner line width near-field exposure to increase the signal track density and storage capacity of the disk.

FIG. 3 shows a second embodiment of the present invention. According to this embodiment, the near-field optical flying head 50 is shown comprising a carrier 60, a SIL (solid immersion lens) 70, and a focusing lens 80. The refraction face 72 of the SIL 70 is plated with a mask layer 74. The outer surface of the mask layer 74 is plated with a silicon nitride dielectric layer 76. The material of the mask layer 74 can be In (indium), Te (technetium), or Sb (antimony). When laser beam focused onto the refraction face 72 of the SIL 70, the focused point of the mask layer 74 is fused, causing a refraction index difference between the fused part and non-fused part of the mask layer 74, and therefore an optical aperture is opened for the passing of laser beam onto the disk. Because the diameter of the light spot at the disk is so small, minor line width can be exposed to laser beam. Therefore, this embodiment greatly improves the storage capacity of the disk.

A prototype of near-field optical flying head has been constructed with the features of FIGS. 2 and 3. The near-field optical flying head functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A near-field optical flying head for near-field recording on a disk, comprising:
a carrier maintained in a near-field distance from the surface of the disk to be recorded;
a solid immersion lens of semispherical shape installed in one side of said carrier facing the disk to be recorded, said solid immersion lens having refraction face facing the disk to be recorded; and
a focusing lens installed in said carrier and spaced from said solid immersion lens at an inner side, adapted to focus a laser beam onto said solid immersion lens, enabling a part of electromagnetic wave to pass through said refraction face and to make a near-field exposure to the disk to be recorded;
wherein said solid immersion lens comprises a light scattering layer plated on said refraction face, which causes a chemical reaction to release silver atoms and to enhance electromagnetic wave passing through said refraction face in providing a small optical aperture for the passing of electromagnetic wave when received light energy or heat energy and is reduced to original compound after disappearance of the light energy or heat energy, and a dielectric layer plated on said light scattering layer and adapted to prohibit escaping of gas which is generated during chemical reaction of said light scattering layer.

2. The near-field optical flying head as claimed in claim 1 wherein said light scattering layer is made of AgOx (silver oxide) that releases silver atoms when received heat energy.

3. The near-field optical flying head as claimed in claim 1 wherein said light scattering layer is made of one of a series of AgX (silver halide) compounds including AgF (silver fluoride), AgCl (silver chloride), AgBr (silver bromide), AgI (silver iodide), and AgAt (silver astatide).

4. The near-field optical flying head as claimed in claim 1 wherein said light scattering layer covers the whole area of said refraction face of said solid immersion lens.

5. The near-field optical flying head as claimed in claim 1 wherein said light scattering layer covers the center area of said refraction face of said solid immersion lens.

6. The near-field optical flying head as claimed in claim 1 wherein said dielectric layer is made of one of the materials of silicon nitride (Si₃N₄) and zinc sulfide-silicon dioxide (ZnS—SiO₂).

7. A near-field optical flying head for near-field recording on a disk, comprising:
a carrier maintained in a near-field distance from the surface of the disk to be recorded;
a solid immersion lens of semispherical shape installed in one side of said carrier facing the disk to be recorded, said solid immersion lens having refraction face facing the disk to be recorded; and
a focusing lens installed in said carrier and spaced from said solid immersion lens at an inner side, adapted to focus a laser beam onto said solid immersion lens, enabling a part of electromagnetic wave to pass through said refraction face and to make a near-field exposure to the disk to be recorded;
wherein said solid immersion lens comprises a mask layer plated on said refraction face, which is caused to change the refraction index by heat energy upon transmission of laser beam through said solid immersion lens, providing an optical aperture for the passing of electromagnetic wave, and a dielectric layer plated on said mask layer.

8. The near-field optical flying head as claimed in claim 7 wherein said mask layer is made of one of the materials of In (indium), Te (technetium), and Sb (antimony).

9. The near-field optical flying head as claimed in claim 7 wherein said mask layer covers the whole area of said refraction face of said solid immersion lens.

10. The near-field optical flying head as claimed in claim 7 wherein said mask layer covers the center area of said refraction face of said solid immersion lens.

11. The near-field optical flying head as claimed in claim 7 wherein said dielectric layer is made of one of the materials of silicon nitride (Si₃N₄) and zinc sulfide-silicon dioxide (ZnS—SiO₂).
